(19) United States
(12) Patent Application Publication
(10) Pub. No.: US 2026/0285295 A1
(43) Pub. Date: Sep. 24, 2026

(54) METHOD AND DEVICE FOR CONTROLLING DRIVING FORCE FOR VEHICLE

(71) Applicant: Nissan Motor Co., Ltd., Yokohama-shi, Kanagawa (JP)

(72) Inventors: Hiroki TAKASE, Kanagawa (JP); Hiroyuki TOGASHI, Kanagawa (JP); Naoya MACHIDA, Kanagawa (JP)

(21) Appl. No.: 19/477,512

(22) PCT Filed: Apr. 24, 2023
(86) PCT No.: PCT/JP2023/016148

§ 371 Date: Oct. 22, 2025

(51) Int. Cl. B60W 30/045; B60W 10/08; B60W 40/08; B60W 40/10

(52) U.S. Cl. CPC B60W 30/045; B60W 10/08; B60W 40/08; B60W 40/10; B60W 2040/0881; B60W 2540/223; B60W 2710/083; B60W 2720/403

(57) ABSTRACT

A method and device for controlling driving forces of vehicle front and rear wheels includes calculating a position of a point of application in a vehicle longitudinal direction of a resultant force of cornering forces of the front and rear wheels. A deviation amount of the point of application from a predetermined area in the vehicle longitudinal direction is calculated. The predetermined area includes a seating position of a driver and does not include a vehicle center of gravity. Driving forces of the front wheel and the rear wheel are controlled in an increasing and decreasing manner so as to bring the point of application closer to the predetermined area, depending on which of a vehicle front side and a vehicle rear side the point of application is located with respect to the predetermined area in the vehicle longitudinal direction and according to a magnitude of the deviation amount.

### CROSS-REFERENCE TO RELATED APPLICATIONS

This application is a U.S. national stage application of International Application No. PCT/JP2023/016148, filed on Apr. 24, 2023.

### BACKGROUND

### Technical Field

The present invention relates to a method and device for controlling driving force for a vehicle.

### Background Information

In Japanese Patent Application Publication No. 2016-68649 A described below, setting steering characteristics of a vehicle to neutral steer with the exception of a transition period during which lateral acceleration increases and decreases is described.

### SUMMARY

Setting steering characteristic of a vehicle to neutral steer means that a position of a point of application in the vehicle longitudinal direction of resultant force of cornering forces of front wheels and rear wheels (hereinafter, referred to as the point of application of the resultant force of cornering forces) is set to a position in the vehicle longitudinal direction of the center of gravity of the vehicle. However, when the point of application of the resultant force of cornering forces is set to the center of gravity of the vehicle, there is a risk that a rotational force in the yaw direction is exerted on the driver while the vehicle is turning.

An object of the present invention is to provide a method and device for controlling driving force for vehicle that prevent a rotational force in the yaw direction from being exerted on a driver while a vehicle is turning.

One aspect of the present invention controls driving forces of a front wheel and a rear wheel in such a way that a position of a point of application in a vehicle longitudinal direction of resultant force of cornering forces of the front wheel and the rear wheel falls within a predetermined area in a vehicle longitudinal direction, the predetermined area including a seating position of a driver.

According to the one aspect of the present invention, since the point of application of the resultant force of cornering forces is located in a vicinity of the seating position of the driver, it becomes possible to reduce the rotational force in the yaw direction exerted on the driver that is generated while the vehicle is turning.

The object and advantages of the invention will be realized and attained by means of the elements and combinations particularly pointed out in the claims. It is to be understood that both the foregoing general description and the following detailed description are exemplary and explanatory and are not to be construed as limiting the invention as defined by the claims.

### BRIEF DESCRIPTION OF DRAWINGS

Referring now to the attached drawings which form a part of this original disclosure, illustrative embodiments are shown.

FIG. 1 is a plan view illustrative of a schematic configuration of an example of a vehicle drive device of an embodiment;

FIG. 2 is a block diagram of a functional configuration example of a controller;

FIG. 3 is a block diagram of a functional configuration example of a target front/rear motor torque calculation unit;

FIG. 4 is a block diagram of a functional configuration example of a brake yaw moment control unit;

FIG. 5 is a block diagram of a functional configuration example of a driving force control unit;

FIG. 6 is an explanatory diagram of action of the driving force control unit;

FIG. 7 is a block diagram of a functional configuration example of a driving force allocation correction control unit;

FIG. 8 is a block diagram of a functional configuration example of a front/rear motor torque correction value calculation unit;

FIG. 9 is a block diagram of a functional configuration example of a cornering force calculation unit;

FIG. 10 is a control map used in cornering power calculation;

FIG. 11 is an explanatory diagram of action of a rear motor torque correction value calculation unit;

FIG. 12 is an explanatory diagram of action of driving force control corresponding to a seating position of a driver;

FIG. 13 is an explanatory diagram of action by a comparative example of the driving force control;

FIG. 14 is a flowchart of calculation processing performed by a vehicle gravity center-driver seating position distance calculation unit;

FIG. 15 is an explanatory diagram detailing the seating position of the driver;

FIG. 16 is an explanatory diagram of simulation of the driving force control by the controller and the comparative example;

FIG. 17 is a timing chart of a steering angle by the simulation; and

FIG. 18 is a timing chart of line tracing by the simulation.

### DESCRIPTION OF EMBODIMENTS

A drive device of an embodiment illustrated in FIG. 1 includes a front motor 2f that drives front wheels 1fl and 1fr (front axle 10f) and a rear motor 2r that drives rear wheels 1rl and 1rr (rear axle 10r). Both the front motor 2f and the rear motor 2r are three-phase AC electric motors. Therefore, a vehicle in this embodiment is an electric four-wheel drive vehicle that drives each of the front wheels 1fl and 1fr and the rear wheels 1rl and 1rr with a separate electric motor. The vehicle is equipped with a driving battery 4 that supplies power to the front motor 2f and the rear motor 2r. The battery 4 is a DC storage battery that enables high-voltage high-current power to be generated. To convert DC power from the battery 4 to three-phase AC power and apply the AC power to the front motor 2f and the rear motor 2r, a front inverter 3f and a rear inverter 3r are provided for the front motor 2f and the rear motor 2r, respectively. The front inverter 3f and the rear inverter 3r also have a function of causing the front motor 2f and the rear motor 2r to perform regenerative operation to charge the battery 4, respectively. The front inverter 3f and the rear inverter 3r are capable of adjusting rotational states of the front motor 2f and the rear motor 2r, such as driving torque and regenerative torque, by adjusting power applied to or regenerative power from the front motor 2f and the rear motor 2r. The driving (regenerative) torque of the front motor 2f and rear motor 2r adjusted by the front inverter 3f and rear inverter 3r can be controlled in accordance with a command signal from a controller, respectively.

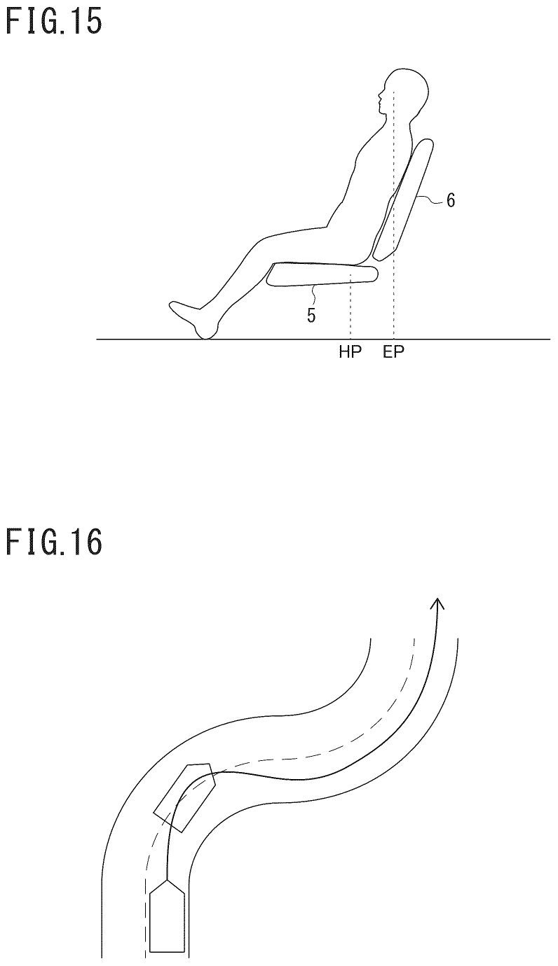

In the vehicle, a driver seat position sensor 7 to detect a vehicle longitudinal position of a driver seat 5 (see FIG. 15) and a driver seat reclining angle sensor 8 to detect a reclining angle (reclining inclination angle) of a seat back 6 of the driver seat 5 are provided. In addition, in the vehicle, a travel characteristic selection switch 9 that enables selection of a traveling state of the vehicle, particularly travel characteristics when the vehicle is turning, is provided. The travel characteristic selection switch 9 is a switch that enables selection of a stable turning mode in which the vehicle exerts stable turning characteristics on a slippery road surface such as a snow road and a sport turning mode in which the vehicle exerts quick turning characteristics on a winding road or the like. Note that when the vehicle longitudinal position of the driver seat 5 and the reclining inclination angle of the seat back 6 are adjusted by actuators such as electric motors, it may be configured to detect the vehicle longitudinal position of the driver seat 5 and the reclining inclination angle of the seat back 6 of the driver seat 5 from, instead of sensors, operation amounts (operating states) of the actuators.

A controller 11 is an electronic control unit (ECU) that controls rotational states of the front motor 2f and the rear motor 2r, in particular driving forces (driving torque) provided to the front wheels 1fl and 1fr and the rear wheels 1rl and 1rr. Therefore, the controller 11 includes a computer system that has advanced calculation processing capabilities. The computer system, as with well-known computer systems, includes a processor 12 that exerts advanced calculation processing capabilities and a storage device 13 that stores information about programs and sensor signals. The processor 12 is constituted by, for example, a central processing unit (CPU) or a micro-processing unit (MPU). The storage device 13 includes a semiconductor storage device, a magnetic storage device, and an optical storage device. The storage device 13 may further include a memory that is used as registers, a cache memory, and a main storage device. Calculation processing executed by the controller 11 is achieved by, for example, the processor 12 executing computer programs stored in the storage device 13 of the controller 11. In addition, the calculation processing executed by the controller 11 may be executed by a functional logic circuit that is implemented in a general-purpose semiconductor integrated circuit. For example, the controller 11 may include a programmable logic device, such as a field-programmable gate array, and the like.

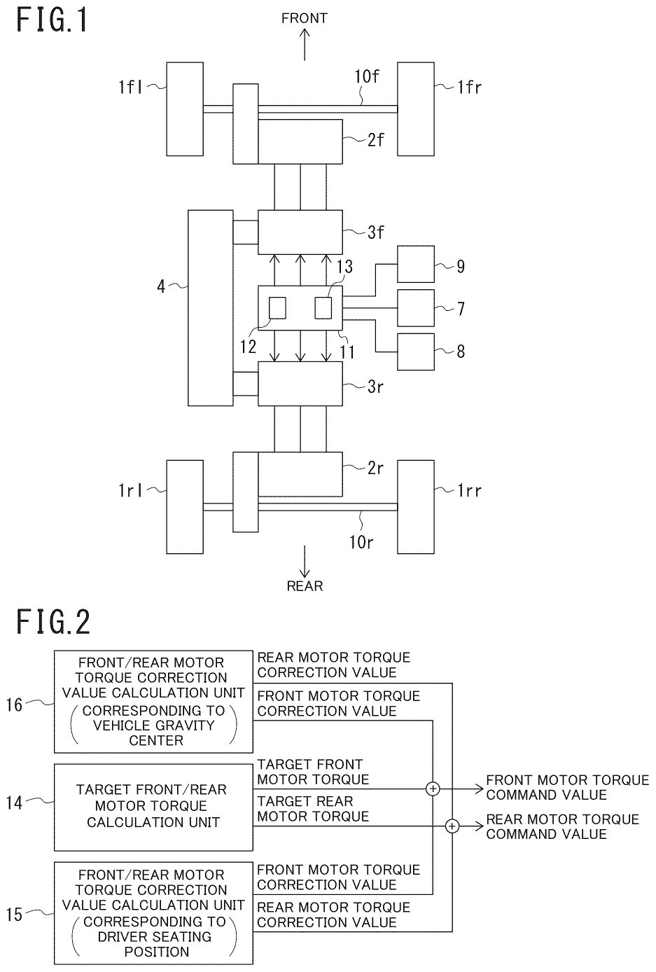

FIG. 2 illustrates logic of calculation processing that is executed by the controller 11 and that calculates command values of front motor torque and rear motor torque that the front motor 2f and the rear motor 2r are commanded to generate, respectively and outputs command signals. In the calculation processing, while a target front motor torque and a target rear motor torque are calculated by a target front/rear motor torque calculation unit 14, a front motor torque correction value and a rear motor torque correction value are calculated by two front/rear motor torque correction value calculation units 15 and 16. The above-described front motor torque correction values and rear motor torque correction values are a front motor torque correction value and a rear motor torque correction value corresponding to a seating position of a driver and a front motor torque correction value and a rear motor torque correction value corresponding to a position of the center of gravity of the vehicle. The front motor torque correction value and the rear motor torque correction value corresponding to the position of the center of gravity of the vehicle and the front motor torque correction value and the rear motor torque correction value corresponding to the seating position of the driver can be switched according to a selection state of the travel characteristic selection switch 9. As described before, when the stable turning mode is selected, the front motor torque correction value and the rear motor torque correction value corresponding to the position of the center of gravity of the vehicle are selected. On the other hand, when the sport turning mode is selected, the front motor torque correction value and the rear motor torque correction value corresponding to the seating position of the driver are selected. A value obtained by adding the selected front motor torque correction value to the target front motor torque is output as a front motor torque command value, and a value obtained by adding the selected rear motor torque correction value to the target rear motor torque is also output as a rear motor torque command value.

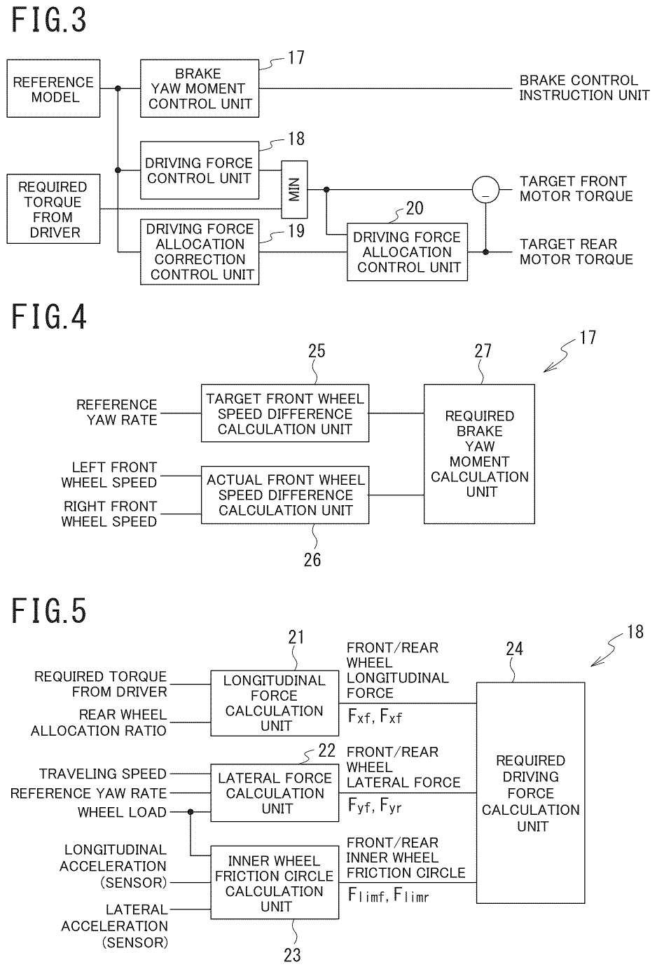

As it is conjectured from the above description, the target front motor torque and the target rear motor torque are reference values to which the front motor torque correction value and the rear motor torque correction value corresponding to the seating position of the driver or the center of gravity of the vehicle are added, respectively. Although calculation logic of the motor torque reference values will be described below with reference to FIG. 3, the description will be kept concise since the calculation logic is not directly involved with the essential part of the present invention. Note that front/rear wheel driving force control of the present embodiment is performed using the driving force to the rear wheels 1rl and 1rr as a primary force and the driving force to the front wheels 1fl and 1fr as a secondary force. That is, travel characteristics as a rear wheel drive vehicle are mainly emphasized, and driving force is allocated to the front wheels 1fl and 1fr for the purpose of improvement of travel characteristics at the time of acceleration and deceleration or at the time of turning. In addition, in the calculation processing in FIG. 3, to achieve line tracking performance at the time of turning on a slippery surface such as a snow road, driving force and braking are controlled in an integrated manner in such a way as to be optimized based on grip limits of tires.

For the brake control, a brake yaw moment control unit 17 calculates a brake control command value from a reference yaw rate provided by a reference model, front left wheel speed, and front right wheel speed, and outputs a control signal to a not-illustrated brake control controller. The brake yaw moment control unit 17, by focusing on front inner wheel spin that triggers occurrence of understeer, controls a front inner wheel brake before a vehicle behavior occurs. Through this operation, the brake yaw moment control unit 17 suppresses front inner wheel spin tendency at the time of acceleration in turning, and suppresses occurrence of understeer after steady turn. FIG. 4 is a block diagram of a functional configuration example of the brake yaw moment control unit 17. Specifically, logic of calculation processing of calculating a brake control command value and outputting a control signal is illustrated. For that purpose, a target front wheel speed difference calculation unit 25 calculates a target front wheel speed difference, using the reference yaw rate. Specifically, a value obtained by multiplying front wheel tread by the reference yaw rate is set as a target front wheel speed difference, which is obtained by subtracting front turning inner wheel speed from front turning outer wheel speed. On the other hand, an actual front wheel speed difference calculation unit 26 assigns detected front left wheel speed and front right wheel speed to front turning inner/outer wheel speeds and calculates an actual front wheel speed difference by subtracting the front turning inner wheel speed from the front turning outer wheel speed. A required brake yaw moment calculation unit 27 sets brake control command values for the front left/right wheels 1fl and 1fr in such a way that the actual front wheel speed difference coincides with the target front wheel speed difference, and outputs a command signal to a front wheel brake actuator or the controller.

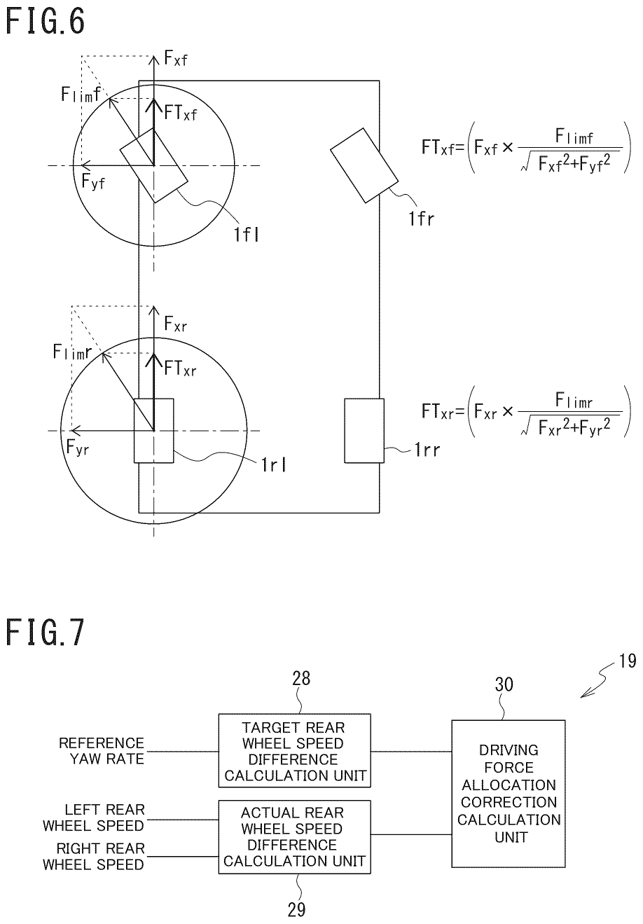

FIG. 5 is a block diagram of a functional configuration example of a driving force control unit 18 in FIG. 3. Specifically, FIG. 5 illustrates logic of calculation processing of calculating required driving force that is optimally limited in accordance with an estimated friction circle in such a way that the required driving force does not immediately exceed a tire friction circle due to a high-response motor. Because of this configuration, the driving force control unit 18 suppresses change in yaw due to initial wheel spin at the time of acceleration in turning and improves the line tracking performance. For that purpose, a longitudinal force calculation unit 21 calculates longitudinal forces Fxf and Fxr of the front and rear wheels generated by operation by the driver, based on required torque by the driver (corresponding to, for example, throttle opening) and a rear wheel allocation ratio. On the other hand, a lateral force calculation unit 22 calculates lateral forces Fyf and Fyr of the front and rear wheels exerted on the turning inner wheels, based on traveling speed of the vehicle, the reference yaw rate, and wheel loads of the wheels. In addition, an inner wheel friction circle calculation unit 23 calculates friction circles Flimf and Flimr of the front and rear inner wheels, based on the wheel loads of the wheels and detected longitudinal acceleration and lateral acceleration. Radius of a friction circle for each wheel can be calculated under the assumption that a square sum of a product of the wheel load of each wheel and the lateral acceleration and a product of the wheel load of the wheel and the longitudinal acceleration is equal to a square of the friction circle radius. The wheel load of each wheel can be obtained from vehicle weight, lateral acceleration, and longitudinal acceleration (and vehicle specifications), as described later. A required driving force calculation unit 24, by restricting the longitudinal forces Fxf and Fxr of the front and rear turning inner wheels, calculates required driving forces FTxr and FTxf of the front and rear inner wheels, as illustrated in FIG. 6. That is, the required driving force calculation unit 24 restricts resultant forces of the longitudinal forces Fxf and Fxr and the lateral forces Fyf and Fyr of the front and rear turning inner wheels by the friction circles Flimf and Flimr of the front and rear inner wheels, and calculates vehicle longitudinal component forces of the restricted resultant forces as the required driving forces FTxf and FTxr.

FIG. 7 is a block diagram of a functional configuration example of a driving force allocation correction control unit 19 in FIG. 3. Specifically, the driving force allocation correction control unit 19, by focusing on rear inner wheel spin that triggers occurrence of oversteer, corrects front and rear driving force allocation before a vehicle behavior occurs. Through this operation, the driving force allocation correction control unit 19, by suppressing rear skid due to rear inner wheel spin at the time of acceleration in turning and moderating a yaw jerk, reduces a load of correction operation. For that purpose, a target rear wheel speed difference calculation unit 28 calculates a target rear wheel speed difference, using the reference yaw rate. Specifically, a value obtained by multiplying rear wheel tread by the reference yaw rate is set as a target rear wheel speed difference, which is obtained by subtracting rear turning inner wheel speed from rear turning outer wheel speed. On the other hand, an actual rear wheel speed difference calculation unit 29 assigns detected rear left wheel speed and rear right wheel speed to rear turning inner/outer wheel speeds and calculates an actual rear wheel speed difference by subtracting the rear turning inner wheel speed from the rear turning outer wheel speed. A driving force allocation correction calculation unit 30 calculates a driving force allocation correction value in such a way that the actual rear wheel speed difference coincides with the target rear wheel speed difference.

Returning to FIG. 3, a driving force allocation control unit 20 corrects driving force allocation to the front and rear wheels (for example, a rear wheel driving force allocation ratio), using the driving force allocation correction value calculated by the driving force allocation correction control unit 19. The driving force allocation control unit 20 selects a smaller one of the required driving force calculated by the driving force control unit 18 and required torque (driving force) by the driver and, by allocating the selected one to the rear wheels 1rl and 1rr side with the corrected driving force allocation, calculates target rear motor torque. In addition, the driving force allocation control unit 20 calculates target front motor torque by subtracting the target rear motor torque from the selected required driving force.

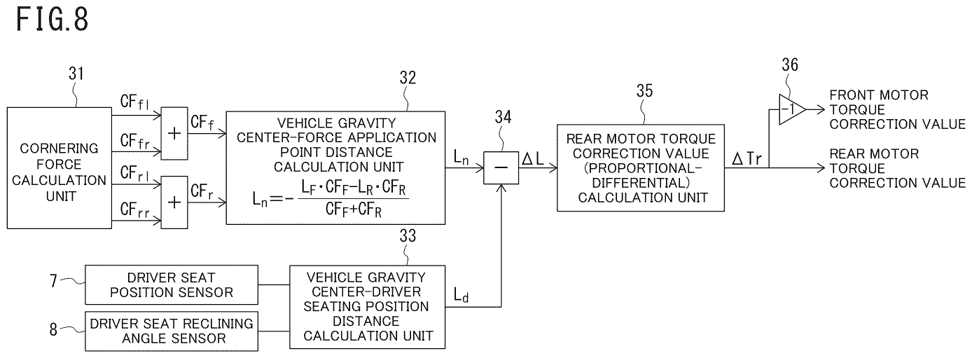

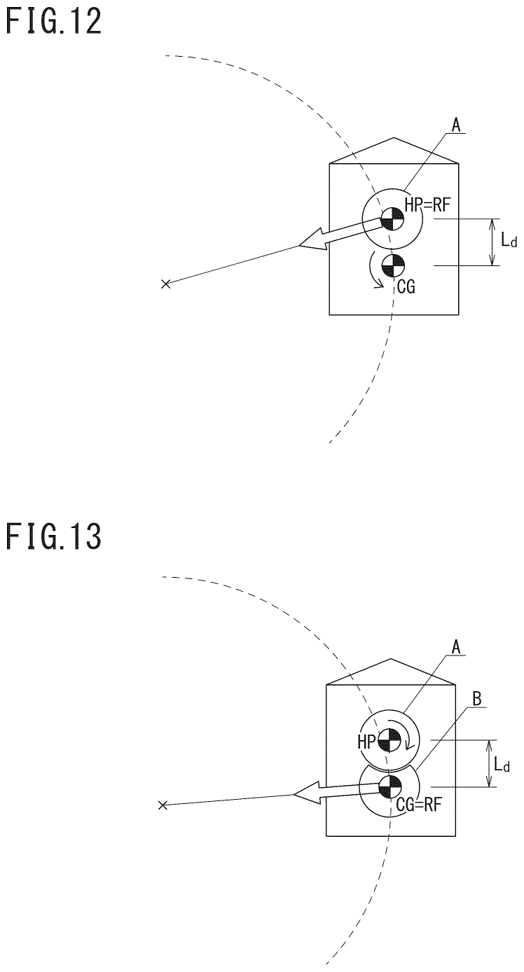

FIG. 8 is a block diagram of a functional configuration example of the front/rear motor torque correction value calculation unit 15 corresponding to the seating position of the driver. Specifically, FIG. 8 illustrates logic of calculation processing of calculating the front and rear motor torque correction values to adjust a point of application in the vehicle longitudinal direction of resultant force RF of cornering forces of the front wheels 1fl and 1fr (front axle 10f) and the rear wheels 1rl and 1rr (rear axle 10r) (a point of application of resultant force RF of cornering forces) in such a way that rotational force in the yaw direction is unlikely to be exerted on the driver. For that purpose, a cornering force calculation unit 31 calculates cornering force of each wheel in accordance with calculation processing, which will be described later. The cornering force calculation unit 31 calculates front wheel (front axle) cornering force CFf by adding front left wheel cornering force CFfl and front right wheel cornering force CFfr and also calculates rear wheel (rear axle) cornering force CFr by adding rear left wheel cornering force CFrl and rear right wheel cornering force CFrr. Next, a vehicle gravity center-force application point distance calculation unit 32 calculates vehicle gravity center-force application point distance Ln in accordance with the following formula (1). The vehicle gravity center-force application point distance Ln is distance between a position of the point of application of the resultant force RF of cornering forces and a position in the vehicle longitudinal direction of a center of gravity CG of the vehicle (see FIG. 12) (hereinafter, referred to as a position of the center of gravity CG of the vehicle). In addition, in the formula, Lf denotes distance in the vehicle longitudinal direction between the center of gravity CG of the vehicle and the left/right front wheels 1fl and 1fr (front axle 10f), and Lr denotes distance in the vehicle longitudinal direction between the center of gravity CG of the vehicle and the left/right rear wheels 1rl and 1rr (rear axle 10r).

$$\begin{matrix}[ Math . 1 ] & \\ {L}_{n} = - \frac{{L}_{f} \cdot {CF}_{f} - {L}_{r} \cdot {CF}_{r}}{{CF}_{f} + {CF}_{r}} & ( 1 )\end{matrix}$$

On the other hand, in accordance with calculation processing, which will be described later, a vehicle gravity center-driver seating position distance calculation unit 33 calculates vehicle gravity center-driver seating position distance Ld. The vehicle gravity center-driver seating position distance Ld is distance in the vehicle longitudinal direction between a seating position HP of the driver and a position of the center of gravity CG of the vehicle. Next, an adder/subtractor 34 calculates a distance difference ΔL by subtracting the vehicle gravity center-driver seating position distance Ld from the vehicle gravity center-force application point distance Ln. A rear motor torque correction value calculation unit 35 calculates a rear motor torque correction value ΔTr matching the distance difference ΔL. Herein, the rear motor torque correction value calculation unit 35 calculates the rear motor torque correction value ΔTr in such a way that the distance difference ΔL becomes 0, that is, the point of application of the resultant force RF of cornering forces coincides with the seating position of the driver. In this configuration, to improve responsiveness of front/rear motor torque, the rear motor torque correction value ΔTr is set using proportional-differential control for the distance difference ΔL. The positive and negative of the rear motor torque correction value ΔTr are inverted by an inverter 36 and a front motor torque correction value ΔTf is calculated.

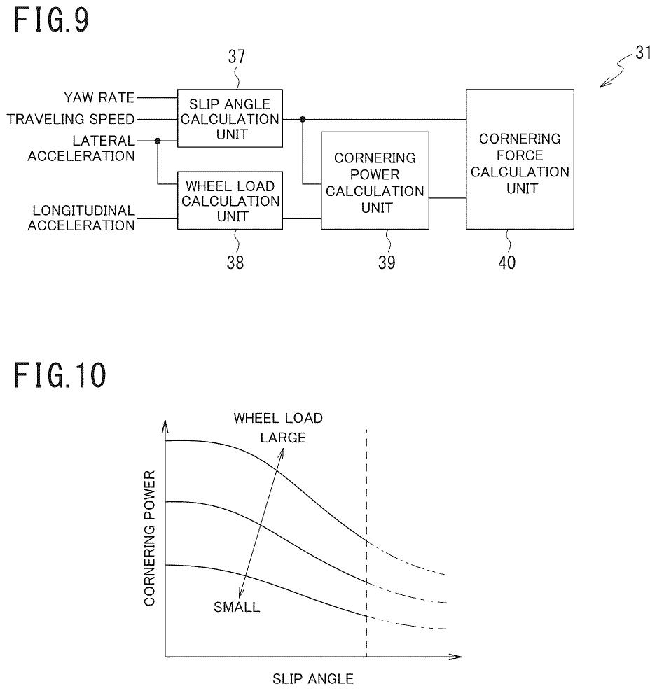

FIG. 9 is a block diagram of a functional configuration example of the cornering force calculation unit 31. Specifically, FIG. 9 illustrates logic of calculation processing of calculating cornering forces CFfl to CFrr of the wheels. For that purpose, a slip angle calculation unit 37 calculates a slip angle of the vehicle (vehicle body), based on a detected yaw rate, traveling speed, and lateral acceleration. Specifically, the slip angle calculation unit 37 calculates a differential value of the slip angle by subtracting the yaw rate from a value obtained by dividing the lateral acceleration by the traveling speed, and calculates a slip angle of the vehicle by integrating the differential value using, for example, a low-pass filter. In addition, a wheel load calculation unit 38 calculates a wheel load of each wheel, based on the detected lateral acceleration and longitudinal acceleration. When the wheel load of each wheel is calculated, by allocating the entire vehicle weight, based on weight allocation characteristics, the wheel load of each wheel in a stationary state is calculated. The amount of load movement in the lateral direction of the vehicle is obtained by dividing a product of the lateral acceleration, mass of the vehicle, and height of the center of gravity of the vehicle by the tread. The amount of load movement in the longitudinal direction of the vehicle is obtained by dividing a product of the longitudinal acceleration, the mass of the vehicle, and the height of the center of gravity of the vehicle by a wheelbase. The wheel load of each wheel is obtained by adding or subtracting the amount of load movement to or from the wheel load of the wheel in the stationary state, depending on a vehicle turning state. When the slip angle of the vehicle and the wheel load of each wheel are obtained, a cornering power calculation unit 39 calculates cornering power of each wheel. In this calculation, a control map for calculation of cornering power matching the slip angle using a wheel load as a parameter as illustrated in FIG. 10 is acquired through simulation or the like and stored in advance, and cornering power of each wheel is calculated from the control map. When the cornering power of each wheel and the slip angle of the vehicle are obtained in this manner, a cornering force calculation unit 40 calculates cornering force from a product of the cornering power of each wheel and the slip angle of the vehicle.

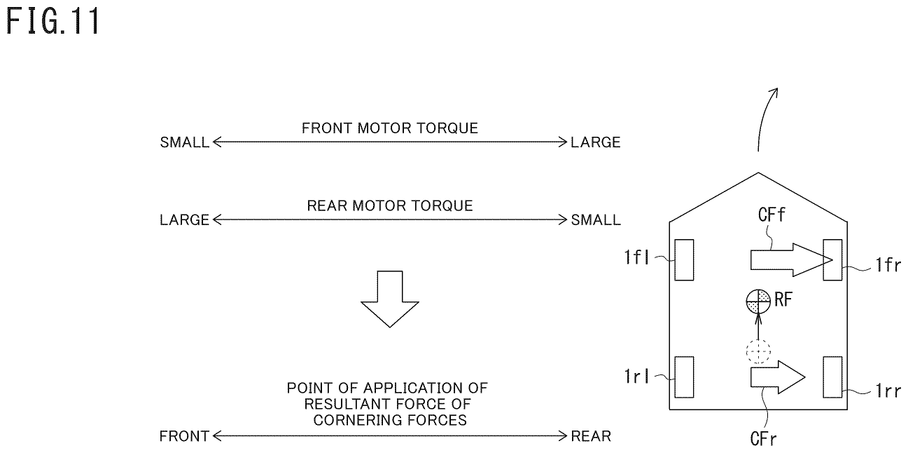

Before describing calculation processing by the vehicle gravity center-driver seating position distance calculation unit 33, action of the front and rear motor torque correction values calculated in the calculation processing in FIG. 8 on the point of application of the resultant force RF of cornering forces will be described. An added value of the front motor torque and the rear motor torque coincides with the required driving force to be input to the driving force allocation control unit 20. Based on the above premise, when, for example, starting from a state in which a ratio of the front motor torque and the rear motor torque is 50:50, the rear motor torque is increased (the front motor torque decreases by the same amount), the cornering force CFr of the rear (left/right) wheels 1rl and 1rr (rear axle 10r) becomes less than the cornering force CFf of the front (left/right) wheels 1fl and 1fr (front axle 10f), as illustrated in the vehicle in FIG. 11, according to the concept of friction circle. As a result, the point of application of the resultant force RF of cornering forces moves toward the front of the vehicle from a position indicated by a dashed line to a position indicated by a solid line, as illustrated in the vehicle in FIG. 11. The chart in FIG. 11 collectively illustrates the above-described relationship. That is, when the front motor torque is increased while the rear motor torque is decreased by the same amount from the front motor torque and the rear motor torque matching the required driving force, the point of application of the resultant force RF of cornering forces is moved toward the rear of the vehicle. Conversely, when the front motor torque is decreased while the rear motor torque is increased by the same amount, the point of application of the resultant force RF of cornering forces is moved toward the front of the vehicle.

Therefore, when as in the calculation processing in FIG. 8, the front motor torque and the rear motor torque are corrected in such a way that the distance difference ΔL between the vehicle gravity center-force application point distance Ln and the vehicle gravity center-driver seating position distance Ld becomes zero, the point of application of the resultant force RF of cornering forces coincides with the seating position HP of the driver seat. When a relationship in the vehicle longitudinal direction between the point of application of the resultant force RF of cornering forces and the seating position HP of the driver seat is reviewed, in a case where the point of application of the resultant force RF of cornering forces is located further in the forward direction of the vehicle than the seating position HP of the driver, it is possible to bring the point of application of the resultant force RF of cornering forces closer to the seating position HP of the driver by controlling the driving forces of the front wheels 1fl and 1fr and the rear wheels 1rl and 1rr in such a way that the driving force of the front wheels 1fl and 1fr increases more than the driving force of the rear wheels 1rl and 1rr. Conversely, in a case where the point of application of the resultant force RF of cornering forces is located further in the rearward direction than the seating position HP of the driver, it is possible to bring the point of application of the resultant force RF of cornering forces closer to the seating position HP of the driver by controlling the driving forces of the front wheels 1fl and 1fr and the rear wheels 1rl and 1rr in such a way that the driving force of the rear wheels 1rl and 1rr increases more than the driving force of the front wheels 1fl and 1fr. On this occasion, a deviation amount of the point of application of the resultant force RF of cornering forces from the seating position HP of the driver is calculated, and in the case where the point of application of the resultant force RF of cornering forces is located further in the forward direction of the vehicle than the seating position HP of the driver, the driving forces of the front wheels 1fl and 1fr and the rear wheels 1rl and 1rr are controlled in such a manner that the larger the deviation amount is, the more the driving force of the front wheels 1fl and 1fr increases than the driving force of the rear wheels 1rl and 1rr. Likewise, in a case where the point of application of the resultant force RF of cornering forces is located further in the rearward direction of the vehicle than the seating position HP of the driver, it is possible to cause the point of application of the resultant force RF of cornering forces to coincide with the seating position HP of the driver by controlling the driving forces of the front wheels 1fl and 1fr and the rear wheels 1rl and 1rr in such a manner that the larger the deviation amount is, the more the driving force of the rear wheels 1rl and 1rr increases than the driving force of the front wheels 1fl and 1fr. Note that the front/rear motor torque correction value calculation unit 16 corresponding to the center of gravity CG of the vehicle does not include the vehicle gravity center-driver seating position distance calculation unit 33 and the adder/subtractor 34, and calculates front and rear motor torque correction values that bring the vehicle gravity center-force application point distance Ln to 0. That is, in the above-described action on the point of application of the resultant force RF of cornering forces, front/rear driving force allocation control that causes the point of application of the resultant force RF of cornering forces to coincide with the center of gravity CG of the vehicle is performed. The front/rear driving force allocation control is driving force control of the front and rear wheels that brings the steering characteristics of the vehicle to neutral steer, and therefore contributes to stable turning travel on a slippery road surface such as a snow road.

In FIG. 12, the seating position of the driver is represented by a hip point HP, which will be described later. As illustrated in FIG. 12, although when the point of application of the resultant force RF of cornering forces coincides with the seating position HP of the driver, a rotational force in the yaw direction in accordance with distance between the point of application of the resultant force RF of cornering forces and the center of gravity CG of the vehicle acts on the center of gravity CG of the vehicle, no rotational force in the yaw direction acts on the seating position HP of the driver seat. This action enables posture of the driver to be stabilized during turning travel, in particular during a transition period such as at the time of acceleration in turning. As a result, it is considered that the number of unnecessary steering inputs is reduced, the number of inputs of correction steering also becomes small, and line tracking performance of the vehicle is improved. On the other hand, FIG. 13 is an explanatory diagram of action of the driving force control of the front and rear wheels where the point of application of the resultant force RF of cornering forces is caused to coincide with the center of gravity CG of the vehicle (comparative example). As described before, since when the point of application of the resultant force RF of cornering forces is caused to coincide with the center of gravity CG of the vehicle, the steering characteristics of the vehicle are maintained in neutral steer, stable turning characteristics can be achieved during a steady turn on a slippery road surface or the like. However, a rotational force in the yaw direction with distance (Ln) between the center of gravity CG of the vehicle and the seating position HP of the driver acting as a moment arm is exerted on the driver. As a result, on a road surface requiring quick change in the turning direction of a steering wheel like a winding road, there is a risk that posture of the driver becomes unstable, unnecessary steering input and large correctional steering are required, and line tracking performance of the vehicle deteriorates.

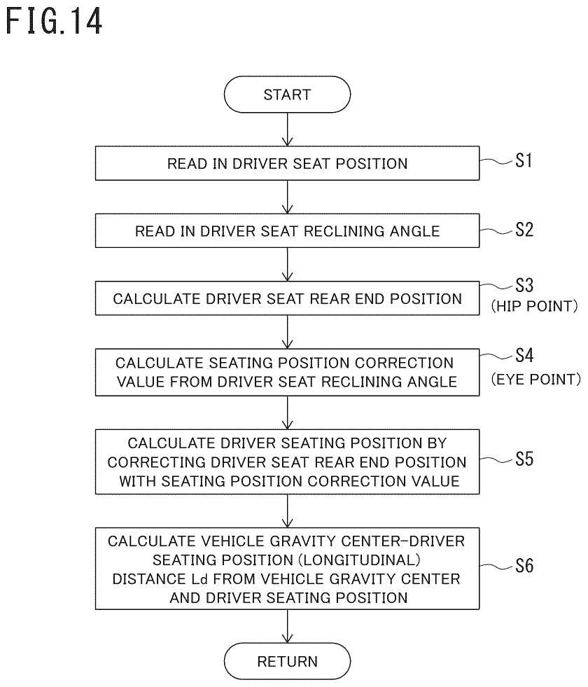

Calculation processing illustrated in FIG. 14 is executed when, for example, a state in which the vehicle is stopping transitions to a state in which the vehicle is traveling. In the calculation processing, first, in step S1, a position in the vehicle longitudinal direction of the driver seat 5 detected by the driver seat position sensor 7 is read in. Next, proceeding to step S2, a reclining inclination angle of the seat back 6 of the driver seat 5 detected by the driver seat reclining angle sensor 8 is read in. Next, proceeding to step S3, a rear end position in the vehicle longitudinal direction of the driver seat 5 is calculated from the read-in position in the vehicle longitudinal direction of the driver seat 5. Next, proceeding to step S4, a seating position correction value is calculated from the read-in reclining inclination angle of the driver seat. Next, proceeding to step S5, a seating position of the driver seat is calculated by correcting the rear end position in the vehicle longitudinal direction of the driver seat 5 with the seating position correction value. Next, proceeding to step S6, a vehicle gravity center-driver seating position distance is calculated from distance in the vehicle longitudinal direction between the center of gravity of the vehicle and the seating position of the driver seat, and the process returns.

FIG. 15 is an explanatory diagram detailing the seating position of the driver set by the calculation processing in FIG. 14. In step S3 of the calculation processing in FIG. 14, a position of the buttocks (ischium), a so-called hip point HP, of the driver who is in contact with the driver seat from the rear end position in the vehicle longitudinal direction of the driver seat 5 is specified. Further, in step S4 of the calculation processing in FIG. 14, a seating position correction value matching a position of the eyes, a so-called eye point EP, of the driver whose upper body (back) leans against the seat back 6 of the driver seat 5 is calculated, and in step S5, a seating position of the driver corresponding to the eye point EP is specified. As described before, when the posture of the driver is to be stabilized during turning travel, it is desirable to stabilize the upper body of the driver to the extent possible, and if possible, it is more desirable to stabilize the position of the eyes of the driver. In the calculation processing in FIG. 14, the eye point EP of the driver is specified as the seating position of the driver, and a vehicle longitudinal distance Ld between the eye point EP and the center of gravity of the vehicle is calculated. Therefore, in the calculation processing in FIG. 8, front and rear motor torque correction values that cause the point of application of the resultant force RF of cornering forces to coincide with the vehicle longitudinal position of the eye point EP of the driver are calculated. Note that it is also possible to, for example, directly detect the eye point EP as the seating position of the driver by extracting the eyes of the driver from an image of the driver through image analysis.

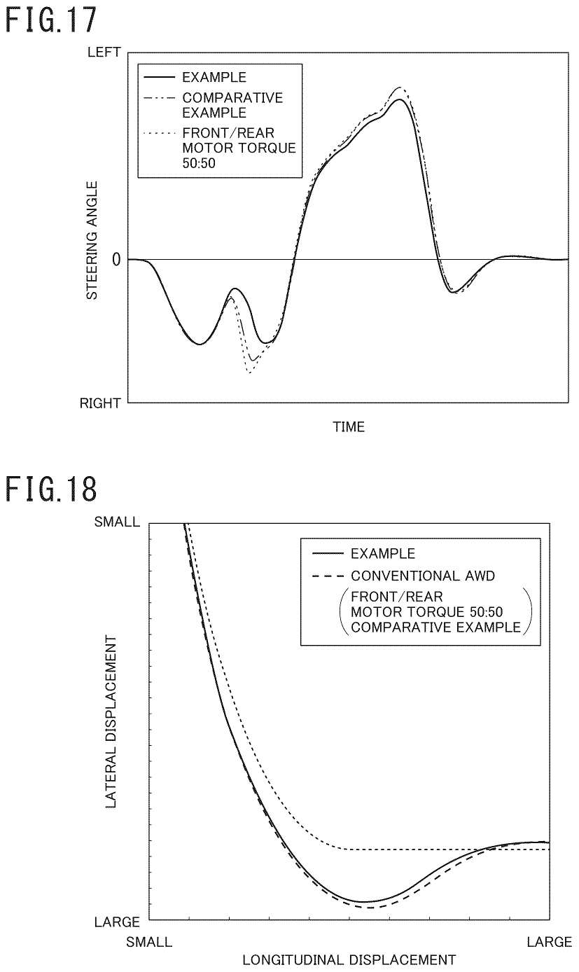

A driving force control device of the present embodiment was installed in a vehicle simulator, and a simulation analysis was performed on a travel state in a chicane illustrated in FIG. 16 in which a vehicle needs to be steered back from rightward steering to leftward steering. It is assumed that as a travel condition, the vehicle, while decelerating from constant speed travel state at a prescribed speed to another prescribed speed, enters the chicane and subsequently, while gradually accelerating, passes an exit corner. As for steering, using a forward gazing model, the vehicle was made to follow the center line of the course as a target. In FIGS. 17 and 18, a timing chart of steering input (steering angle) in a simulation result and a timing chart of line tracing (following) at the exit position are illustrated, respectively. In FIG. 17, a smaller amplitude of a steering angle from a steering angle of 0 indicates smaller steering input and correction steering. Compared with a case of driving force control when a ratio of front motor torque and rear motor torque is 50:50, in the comparative example, that is, a case of driving force control causing the point of application of the resultant force RF of cornering forces to coincide with the center of gravity of the vehicle, the correction steering is slightly reduced. In contrast, in an example of the embodiment, the correction steering is largely reduced. It is evident that, as a result, left turn steering input at the chicane exit is suppressed. In addition, as a result, as illustrated in FIG. 18, the line tracing in the example with respect to the target line has also been improved. As an example, when a vehicle, decelerating from constant speed travel at 78 km/h to 68 km/h, enters the chicane, compared with a conventional electric four-wheel drive vehicle with a front/rear motor torque ratio of 50:50, correction steering, a maximum steering angle, and convergence property of return steering are improved by up to 13%, and as for line traceability, the amount of deviation from the target lane is improved by approximately 400 mm. Note that in the driving force control causing the point of application of the resultant force RF of cornering forces to coincide with the hip point HP of the driver, steerability and line tracking performance are likewise improved.

Although the method and device for controlling driving force for vehicle according the embodiment are described above, the present invention is not limited to the configuration described in the above-described embodiment, and various modification can be made within the scope the present invention. For example, in the above embodiment, the seating position of the driver in the vehicle longitudinal direction is set to a predetermined position, and the driving forces of the front wheels 1fl and 1fr and the rear wheels 1rl and 1rr are controlled in such a way that the point of application of the resultant force RF of cornering forces coincides with the predetermined position. In contrast, the predetermined position may be set as a predetermined range, and the area may be used as an area for the point of application of the resultant force RF of cornering forces of the front wheels 1fl and 1fr and the rear wheels 1rl and 1rr. That is, in the method and device for controlling driving force for vehicle of this aspect, it is essential that the driving forces of the front wheels 1fl and 1fr and the rear wheels 1rl and 1rr are controlled in such a way that the point of application of the resultant force RF of cornering forces of the front wheels 1fl and 1fr and the rear wheels 1rl and 1rr falls within a predetermined area in the vehicle longitudinal direction including the seating position of the driver. As an example, as illustrated in FIG. 12, a range from a position of an accelerator pedal of the vehicle to a rear end position of the driver seat 5 is defined as a predetermined area A in the vehicle longitudinal direction. When distance in the vehicle longitudinal direction between the center of gravity of the vehicle and the seating position of the driver is large, it is possible to reduce a rotational force in the yaw direction experienced by the driver simply by controlling the point of application of the resultant force RF of cornering forces to within the above-described range.

As described above, the device for controlling front/rear driving force for vehicle of the embodiment calculates a position of the point of application of the resultant force RF of cornering forces of the front wheels 1fl and 1fr and the rear wheels 1rl and 1rr, and controls the driving forces of the front wheels 1fl and 1fr and the rear wheels 1rl and 1rr in such a way that the position in the vehicle longitudinal direction of the point of application falls within a predetermined area in the vehicle longitudinal direction including the seating position of the driver. Therefore, since the point of application of the resultant force RF of cornering forces is located in a vicinity of the seating position of the driver, it becomes possible to reduce a rotational force in the yaw direction on the driver that is generated while the vehicle is turning.

In addition, the device for controlling front/rear driving force for vehicle of the embodiment calculates a deviation amount (distance) of the point of application of the resultant force RF of cornering forces from the predetermined area in the vehicle longitudinal direction, controls the driving forces of the front wheels 1fl and 1fr and the rear wheels 1rl and 1rr in such a manner that the further the point of application is located toward the front of the vehicle than the predetermined area in the vehicle longitudinal direction and the larger the deviation amount is, the more the driving force of the front wheels 1fl and 1fr increases than the driving force of the rear wheels 1rl and 1rr, and controls the driving forces of the front wheels 1fl and 1fr and the rear wheels 1rl and 1rr in such a manner that the further the point of application is located toward the rear of the vehicle than the predetermined area in the vehicle longitudinal direction and the larger the deviation amount is, the more the driving force of the rear wheels 1rl and 1rr increases than the driving force of the front wheels 1fl and 1fr. Because of this configuration, by properly adjusting the cornering forces of the front wheels 1fl and 1fr and the rear wheels 1rl and 1rr according to the deviation amount, the point of application of the resultant force RF of cornering forces can be brought to within a predetermined area including the seating position of the driver.

In addition, as illustrated in FIG. 13, the driving forces of the front wheels 1fl and 1fr and the rear wheels 1rl and 1rr are configured to be controllable in such a way that the point of application of the resultant force RF of cornering forces falls within the second predetermined area B in the vehicle longitudinal direction including the center of gravity of the vehicle, and the control that brings the point of application to within the predetermined area A in the vehicle longitudinal direction and the control that brings the point of application to within the second predetermined area B in the vehicle longitudinal direction are configured to be switchable. Because of this configuration, it is possible to obtain stable turning travel on a slippery road surface and quick turning travel with excellent turning performance through switching therebetween. In this switching control, the predetermined area A in the vehicle longitudinal direction for convergence of the point of application of the resultant force RF of cornering forces to a vicinity of the seating position of the driver is preferably a range that includes the seating position of the driver and that does not include the center of gravity of the vehicle. In addition, the second predetermined area B in the vehicle longitudinal direction for convergence of the point of application of the resultant force RF of cornering forces to a vicinity of the center of gravity of the vehicle is preferably a range that includes the center of gravity of the vehicle and that does not include the above-described predetermined area A.

In addition, by detecting a position in the vehicle longitudinal direction of the driver seat 5 and setting a predetermined area in the vehicle longitudinal direction, based on the detected position in the vehicle longitudinal direction of the driver seat 5, in particular the rear end in the vehicle longitudinal direction, it is possible to appropriately set the hip point HP of the driver and stabilize the upper body of the driver during turning.

In addition, by detecting a reclining inclination angle (angle) of the seat back 6 of the driver seat 5 and setting a predetermined area in the vehicle longitudinal direction, based on the detected position in the vehicle longitudinal direction of the driver seat 5, in particular the rear end in the vehicle longitudinal direction and the reclining inclination angle of the seat back 6, it is possible to appropriately set the eye point EP of the driver and stabilize the position of the eyes of the driver during turning.

1. A method for controlling driving force for a vehicle for controlling driving forces of a front wheel and a rear wheel of the vehicle, the method comprising:
calculating a position of a point of application in a vehicle longitudinal direction of a resultant force of cornering forces of the front wheel and the rear wheel;
calculating a deviation amount of the point of application from a predetermined area in the vehicle longitudinal direction, the predetermined area including a seating position of a driver and not including a center of gravity of the vehicle; and
controlling driving forces of the front wheel and the rear wheel in an increasing and decreasing manner so as to bring the point of application closer to the predetermined area, depending on which of a vehicle front side and a vehicle rear side the point of application is located with respect to the predetermined area in the vehicle longitudinal direction and according to a magnitude of the deviation amount.

2. The method for controlling driving force for vehicle according to claim 1, wherein
the method brings a position of the point of application in the vehicle longitudinal direction to within the predetermined area by controlling driving forces of the front wheel and the rear wheel in such a manner that the further the point of application is located toward a front of the vehicle than the predetermined area in the vehicle longitudinal direction and the larger the deviation amount is, the more the driving force of the front wheel increases than the driving force of the rear wheel and controlling driving forces of the front wheel and the rear wheel in such a manner that the further the point of application is located toward a rear of the vehicle than the predetermined area in the vehicle longitudinal direction and the larger the deviation amount is, the more the driving force of the rear wheel increases than the driving force of the front wheel.

3. The method for controlling driving force for vehicle according to claim 1, wherein
driving forces of the front wheel and the rear wheel are configured to be controllable in such a way that a position in the vehicle longitudinal direction of the point of application falls within a second predetermined area in the vehicle longitudinal direction, the second predetermined area including the center of gravity of the vehicle and not including the predetermined area in the vehicle longitudinal direction, and control to bring a position in the vehicle longitudinal direction of the point of application to within a predetermined area in the vehicle longitudinal direction and control to bring the position in the vehicle longitudinal direction of the point of application to within a second predetermined area in the vehicle longitudinal direction are configured to be switchable.

4. The method for controlling driving force for vehicle according to claim 1, wherein
the predetermined area in the vehicle longitudinal direction is a range from an accelerator pedal of the vehicle to a rear end of a driver seat.

5. The method for controlling driving force for vehicle according to claim 1, wherein
the method detects a position in the vehicle longitudinal direction of a driver seat of the vehicle and sets the predetermined area in the vehicle longitudinal direction, based on a detected position in the vehicle longitudinal direction of the driver seat.

6. The method for controlling driving force for vehicle according to claim 5, wherein
the method detects a reclining angle of a seat back of the driver seat of the vehicle and sets the predetermined area in the vehicle longitudinal direction, based on a detected position in the vehicle longitudinal direction of the driver seat and a reclining angle of the seat back.

7. A device for controlling driving force for a vehicle configured to control driving forces of a front wheel and a rear wheel of the vehicle, the device comprising:
a motor for a front wheel configured to provide the front wheel with a driving force;
a motor for a rear wheel configured to provide the rear wheel with a driving force; and
a controller configured to
calculate a position of a point of application in a vehicle longitudinal direction of a resultant force of cornering forces of the front wheel and the rear wheel,
calculate a deviation amount of the point of application from a predetermined area in the vehicle longitudinal direction, the predetermined area including a seating position of a driver and not including a center of gravity of the vehicle
set driving forces of the front wheel and the rear wheel in an increasing and decreasing manner so as to bring the point of application closer to the predetermined area, depending on which of a vehicle front side and a vehicle rear side the point of application is located with respect to the predetermined area in the vehicle longitudinal direction and according to a magnitude of the deviation amount, and
output a control signal to the motor for the front wheel and the motor for the rear wheel.
